(19) United States
(12) Patent Application Publication
(10) Pub. No.: US 2023/0010724 A1
(43) Pub. Date: Jan. 12, 2023

(54) FOOD STORAGE CONTAINER

(71) Applicant: Isamu SATOU, Tokyo (JP)

(72) Inventor: Isamu SATOU, Tokyo (JP)

(21) Appl. No.: 17/945,085

(22) Filed: Sep. 15, 2022

Related U.S. Application Data
(63) Continuation of application No. PCT/JP2020/014993, filed on Apr. 1, 2020.

(51) Int. Cl. B65D 1/34; B65D 25/14

(52) U.S. Cl. CPC B65D 1/34; B65D 25/14

(57) ABSTRACT

To provide a food storage container capable of preventing penetration of blood and juice and there is almost no level difference in the four corners not to generate air space even when a top seal is applied. A food storage container is formed in a heavy paper material from a pulp material, wherein the heavy paper material is coated with a thermoplastic resin having a heat sealability, a folding piece connecting a side face piece with a neighboring side face piece is provided on each of four corners of the heavy paper material, one end of an upper end of the folding piece reaches a position between an inner end of a flange portion of one of the two neighboring side face pieces arranged on an upper surface and an intermediate position of the inner end and an outer end of the flange portion, the other end of the upper end of the folding piece does not reach the flange portion of the other of the two neighboring side face pieces, and the two neighboring side face pieces are overlapped and adhered with each other sandwiching the folding piece. Thus, a connection portion of the flange portions can be formed flatly.

### TECHNICAL FIELD

The present invention relates to a food storage container formed from a pulp material and the like (e.g., pulp material, grass and vegetable resin) and used as a wrap type tray, a top seal type tray and a lunch box container, for example. In more detail, the present invention relates to a food storage container formed in a heavy paper material from a pulp material and the like capable of preventing penetration of blood and juice even when meat, fish and the like are packed in the food storage container and the food storage container is inclined or reversed, eliminating the problems in forming such as breakage and adhesion peeling and enabling complete sealing to prevent the outside air from entering into the food storage container.

### BACKGROUND ART

FIG. 1 shows a conventional food storage container. A folding piece 3 is continuously provided between side face pieces 1 and 2. A folded-back portion 4 having an approximately rectangular shape is formed on a part upper than the folding piece 3 of the side face piece 2 so that the folded-back portion 4 is adhered to the surface of the side face piece 1. Even when the folded-back portion 4 is folded back and adhered to the side face piece 1, cut faces of the pulp material and the like do not appear on the surface. Thus, the problem of penetrating blood and juice into the container and staining the appearance of the container does not occur.

However, three layers are overlapped at a portion where the side walls 1, 2 and the folded-back portion 4 having an approximately rectangular shape are overlapped with each other. Since the thickness is too thick, breakage may occur in forming and peeling of the adhered surface may occur easily. Thus, fraction defective increases and the products are unprofitable. Furthermore, when a top seal is applied to the container, air space is formed due to the level difference caused by large unevenness. Thus, there is a problem that the purpose of the top seal for completely sealing the container cannot be achieved.

### DISCLOSURE OF THE INVENTION

### Problems to be Solved by the Invention

The present invention is made focusing on the above described point and aims for providing a food storage container for solving the problem that the container is easily broken and peeled, improving mass productivity and enabling complete seal.

### Means for Solving the Problem

For achieving the above described purpose, the inventor reached the present invention as a result of the earnest research. The inventor found the configuration that one end of an upper end of the folding piece reaches an intermediate position of a flange portion of one of the two neighboring side face pieces arranged on an upper surface and the other end of the upper end of the folding piece does not reach the flange portion of the other of the two neighboring side face pieces. In the above described configuration, the problem of penetrating blood and juice into the container does not occur since the cut faces do not appear on the inner surface of the container. Furthermore, the thickness of the flange portion is not too thick at a portion where a folded-back portion is not formed.

Namely, the present invention provides a food storage container formed in a heavy paper material from a pulp material, wherein the heavy paper material is coated with a thermoplastic resin having a heat sealability, a folding piece connecting a side face piece with a neighboring side face piece is provided on each of four corners of the heavy paper material, one end of an upper end of the folding piece reaches a position between an inner end of a flange portion of one of the two neighboring side face pieces arranged on an upper surface and an intermediate position of the inner end and an outer end of the flange portion, the other end of the upper end of the folding piece does not reach the flange portion of the other of the two neighboring side face pieces, and the two neighboring side face pieces are overlapped and adhered with each other sandwiching the folding piece. Thus, the present invention is characterized in that the cut faces of the pulp material do not appear on the end portion of the overlapped portion at the inner surface of the container and a portion of the three layers is substantially eliminated.

It is preferred that the one end of the upper end of the folding piece reaches the position of one third to a half in a range from the inner end to the outer end of the flange portion of the one of the two neighboring side face pieces arranged on the upper surface (claim 2).

### Effects of the Invention

As described above, the present invention adopts the configuration that one end of an upper end of the folding piece reaches an intermediate position of the inner end and the outer end of a flange portion of one of the two neighboring side face pieces arranged on an upper surface, the other end of the upper end of the folding piece does not reach the flange portion of the other of the two neighboring side face pieces, and the side face piece and the neighboring side face piece are overlapped and adhered with each other sandwiching the folding piece. Because of this, the problem of penetrating blood and juice into the container and staining the appearance of the container can be solved since the cut faces do not appear on the inner surface of the container. In addition, since a portion of the three layers is substantially eliminated, the problem that the container is easily broken and peeled can be solved. Furthermore, the flatness can be kept even when the top seal is applied. As described above, the present invention has great effects.

### BRIEF DESCRIPTION OF THE DRAWINGS

FIG. 1 is a partially exploded view showing an example of a conventional food storage container.

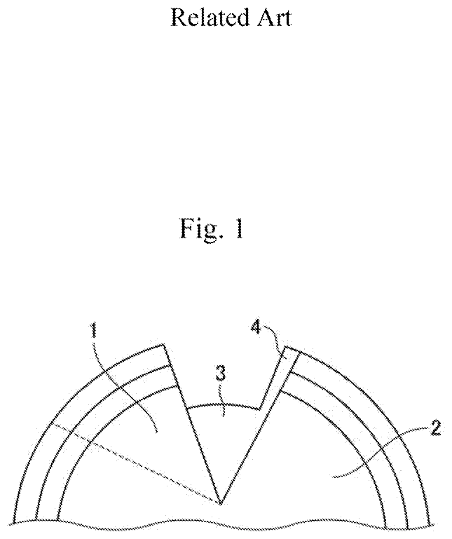

FIG. 2A is a cross-sectional view, FIG. 2B is a partially exploded view and FIG. 2C is a partial cross-sectional view of an example of a food storage container of the present invention.

FIG. 3A is a cross-sectional view, FIG. 3B is a partially exploded view and FIG. 3C is a partial cross-sectional view of another example of the food storage container of the present invention.

FIG. 4 is a partially exploded view of another example of the food storage container of the present invention.

FIG. 5 is a partially exploded view of another example of the food storage container of the present invention.

### DESCRIPTION OF THE REFERENCE NUMERALS

1 . . . side face piece
2 . . . side face piece
3, 3′ . . . folding piece
5 . . . flange portion
6 . . . folded-back portion

### MODES FOR CARRYING OUT THE INVENTION

Then, embodiments of the present invention will be explained.

In the present invention, a food storage container is formed from a pulp material and the like. The food storage container is formed from the pulp material and the like by forming a heavy paper material having a predetermined size from the pulp material and the like, applying a thermoplastic resin having a heat sealability on the reverse surface of the heavy paper material, and pressing the heavy paper material on which cut-off portions are formed at four corners of the heavy paper material for forming side face pieces by heating or high-frequency forming using a pair of recessed and projected press molds, for example. When pressing the heavy paper material, it is required that one of a pair of the side face pieces facing to each other should be raised in advance. Instead of pressing the heavy paper material by the press molds, it is also possible to perform a hot-pressing by blowing hot air.

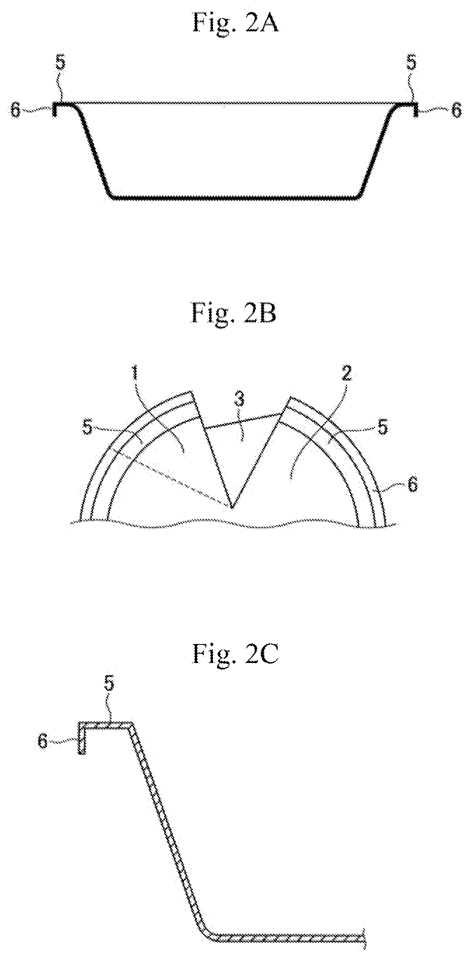

FIGS. 2A to 2C show an embodiment of a tray of the present invention. As shown in FIG. 2B, the folding piece 3 is continuously provided between the side face piece 1 and the side face piece 2, one end of an upper end of the folding piece 3 reaches a position of one third to a half (intermediate position) in a range from the inner end to the outer end of a flange portion 5 of the side face piece 2 arranged on an upper surface, the other end of the upper end of the folding piece 3 does not reach the flange portion 5 of the side face piece 1, and the side face pieces 1, 2 are overlapped and adhered with each other sandwiching the folding piece 3 so that the side face piece 2 is arranged on the upper surface. In the above described embodiment, a folded-back portion 6 is formed on a part upper than the flange portion 5 of the side face piece 2.

In the above described configuration, drip portions can be eliminated from an upper part of an inner surface of four corners and there is almost no level difference (two layers) in the four corners at the position of approximately a half to two thirds from the outer end of the flange portion 5. Thus, the adhesion can be surely attained and air leakage can be prevented even when the top seal is applied. Accordingly, the container of the present invention is an ideal as a container of a top seal type.

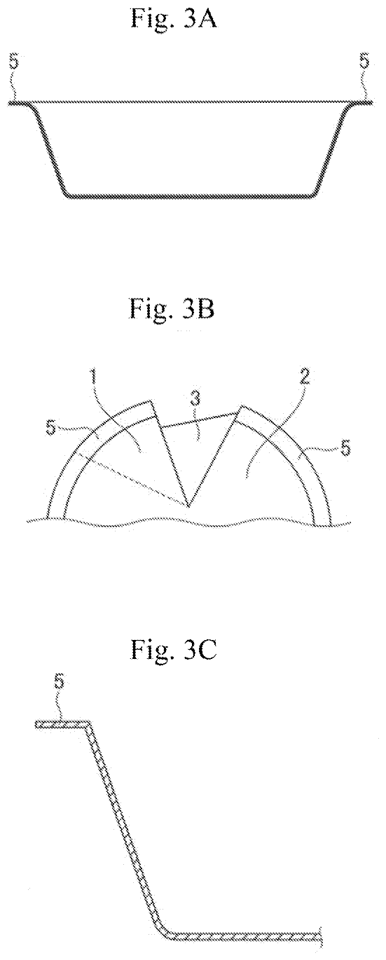

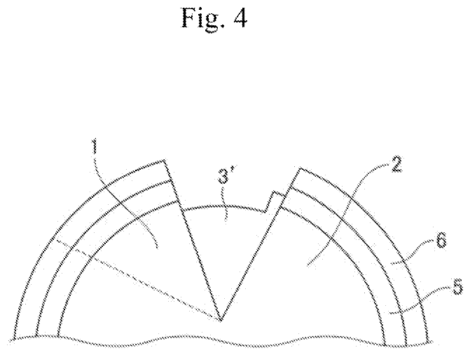

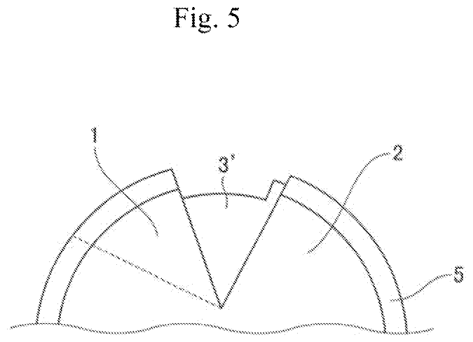

FIG. 3 shows another embodiment of the present invention. The present embodiment is configured similarly as the above described embodiment except for that the folded-back portion 6 is not formed. It is enough if one end of an upper end of the folding piece reaches an intermediate position of one of the two neighboring flange portions arranged on an upper surface and the other end of the upper end of the folding piece does not reach the other of the two neighboring flange portions. The shape of the folding piece is not particularly limited. For example, as shown in FIG. 4 and FIG. 5, it is possible to form a folding piece 3′ having a level difference.

The food storage container manufactured by the method of the present invention is not particularly limited. As a preferable example, food storage containers such as a tray, a lunch box container and an all-purpose container can be listed. In the container manufactured as described above, the cut faces of the pulp material and the like do not appear on the inner surface of the container. Thus, there is no risk of penetrating blood, water and the like of meat, fish and liver from the cut faces. Furthermore, since a portion of the three layers is substantially eliminated, the container can be formed in an approximately flat and the problem in forming can be solved.

### INDUSTRIAL APPLICABILITY

The present invention adopts the configuration that one end of an upper end of the folding piece reaches an intermediate position of a flange portion of one of the two neighboring side face pieces arranged on an upper surface and the other end of the upper end of the folding piece does not reach the flange portion of the other of the two neighboring side face pieces, and the two neighboring side face pieces are overlapped and adhered with each other sandwiching the folding piece. Because of this, the problem of penetrating blood and juice into the container and staining the appearance of the container can be solved since the cut faces do not appear on the inner surface of the container. In addition, since a portion of the three layers is substantially eliminated, the problem that the container is easily broken and peeled can be solved. Furthermore, the long-standing problem for achieving flatness can be solved. Thus, the present invention is expected to be utilized

1. A food storage container formed in a heavy paper material from a pulp material, wherein
the heavy paper material is coated with a thermoplastic resin having a heat sealability,
a folding piece connecting a side face piece with a neighboring side face piece is provided on each of four corners of the heavy paper material,
one end of an upper end of the folding piece reaches a position between an inner end of a flange portion of one of the two neighboring side face pieces arranged on an upper surface and an intermediate position of the inner end and an outer end of the flange portion,
the other end of the upper end of the folding piece does not reach the flange portion of the other of the two neighboring side face pieces, and
the two neighboring side face pieces are overlapped and adhered with each other sandwiching the folding piece.

2. The food storage container according to claim 1, wherein
the one end of the upper end of the folding piece reaches the position of one third to a half in a range from the inner end to the outer end of the flange portion of the one of the two neighboring side face pieces arranged on the upper surface.

3. The food storage container according to claim 1, wherein
the food storage container is configured to be used for a top seal.

4. The food storage container according to claim 2, wherein
the food storage container is configured to be used for a top seal.
